(19) United States
(12) Patent Application Publication
(10) Pub. No.: US 2021/0053704 A1
(43) Pub. Date: Feb. 25, 2021

(54) CONTAINER CARRIER APPLICATION SYSTEM

(71) Applicant: Oregon Precision Industries, Inc. dba PakTech, Eugene, OR (US)

(72) Inventors: Zachary Alan Edwards, Eugene, OR (US); Robert Michael McKenna, Eugene, OR (US); Nicholas James Roche, Eugene, OR (US); Jeremy Rollin Pond, Eugene, OR (US); Brent Thomas Nasset, Eugene, OR (US)

(21) Appl. No.: 16/547,336

(22) Filed: Aug. 21, 2019

(51) Int. Cl. B65B 7/28; B65B 43/52; G05B 19/05

(52) U.S. Cl. CPC B65B 7/2842; G05B 19/05; B65B 43/52

(57) ABSTRACT

A container carrier application system is provided. The system includes a controller, a conveyor, a container positioning device, and an application device. The conveyor conveys a plurality of groups of containers from a supply side to an output side. The container positioning device positions each group of containers for application of a container carrier, and the application device applies the container carrier to the group. A motion of the container positioning device and a motion of the application device are synchronized to coordinate a position of the group with a position of the container carrier to be applied to the group. The controller is configured to control a conveyance speed of the groups such that a gap is introduced between a first group and a second group as they are conveyed along the conveyor, the gap being spaced in a conveyance direction of the containers.

### TECHNICAL FIELD

The present application relates generally to a container carrier application system, which applies container carriers to groups of multiple containers, and more particularly to container carrier application systems that apply container carriers that extend vertically down outside surfaces of the containers.

### BACKGROUND

Container carriers are used to secure groups of containers so that they may be grasped and carried by a user as a single unit. Specialized machines may be used to apply a container carrier to a group of containers in a manufacturing line. These machines typically utilize rotary wheels to align containers for the application of the container carrier, and the containers in a leading group are in contact with containers in a lagging group. Conventionally, the container carriers are shaped to remain within an area bounded by a footprint of the group of containers, and do not to interfere with adjacent groups. A challenge exists in positioning groups of containers for the application of container carriers that extend vertically down the outside surfaces of the containers, thereby requiring a space between the containers in the leading group and the containers in the lagging group.

### SUMMARY

To address the above issues, a container carrier application system and a method therefor are provided. According to a first aspect, a container carrier application system may comprise a controller, a conveyor, a container positioning device, and an application device. The conveyor may be configured to, under the command of the controller, convey a plurality of groups of containers from a supply side to an output side, a container of a first group being in contact with at least one container of a second group. The container positioning device may be configured to, under command of the controller, position each group of containers on the conveyor for application of a container carrier to the group of containers. The application device may be configured to, under command of the controller, apply the container carrier to the group of containers. A motion of the container positioning device and a motion of the application device may be synchronized to coordinate a position of the group of containers with a position of the container carrier to be applied to the group of containers. The controller may be configured to control a conveyance speed of the plurality of groups of containers such that a gap is introduced between the first group and the second group of the plurality of groups as they are conveyed along the conveyor toward the application device, the gap being spaced in a conveyance direction of the groups of containers. A potential advantage of this configuration is that a container carrier may be securely applied the first group of containers without interference from the second group of containers.

In this aspect, the controller may be a programmable logic controller, and a first servomechanism and a second servomechanism may be electronically linked to one another and controlled via the programmable logic controller. A potential advantage of this configuration is two components of the applicator system may be cooperatively controlled via the programmable logic controller such that the conveyance of the containers coordinates with the application of the container carrier.

In this aspect, the first servomechanism may be configured to control the container positioning device to refrain from conveying the second group of containers until the first group of containers reaches a predetermined distance from the container positioning device to introduce the gap between the first and second groups of containers. A potential advantage of this configuration is that a container carrier may be securely applied to the first group of containers without interference from the second group of containers.

In this aspect, the second servomechanism may be configured to control the application device to accelerate when seating the container carrier on the first group of containers to introduce the gap between the first and second groups of containers. A potential advantage of this configuration is that a container carrier may be securely applied to the first group of containers without interference from the second group of containers.

In this aspect, the application device may include a roller applicator to secure the container carrier onto top surfaces of the containers, and the roller applicator may be formed in a shape complimentary to a shape of a top surface of the container carrier. A potential advantage of this configuration is that a container carrier may be firmly seated on a group of containers.

In this aspect, the roller applicator may be adjustable in height. A potential advantage of this configuration is that the roller applicator of the system may be used to firmly seat container carriers on containers of different heights.

In this aspect, the application device may include a stomp applicator that applies a downward force to press the container carrier onto top surfaces of the containers. A potential advantage of this configuration is that a container carrier may be firmly seated on a group of containers.

In this aspect, the stomp applicator may be adjustable in height. A potential advantage of this configuration is that the stomp applicator of the system may be used to firmly seat container carriers on containers of different heights.

In this aspect, the container carrier application system may further include a sensor configured to detect when the first group of containers reaches a predetermined distance from the container positioning device. A potential advantage of this configuration is that gaps between groups of containers can be consistently and accurately timed.

In this aspect, the container carrier application system may further include a sensor configured to detect when the roller applicator engages the container carrier on the first group of containers. A potential advantage of this configuration is that gaps between groups of containers can be consistently and accurately timed.

In another aspect, a method for a container carrier application system is provided. The method may include providing a controller to control the container carrier application system. The method may further include configuring a conveyor to, under command of the controller, convey a plurality of groups of containers from a supply side to an output side, a container of a first group being in contact with at least one container of a second group. The method may further include configuring a container positioning device to, under command of the controller, position each group of containers on the conveyor for application of a container carrier to the group of containers. The method may further include configuring an application device to, under command of the controller, apply the container carrier to the group of containers. The method may further include synchronizing a motion of the container positioning device and a motion of the application device to coordinate a position of the group of containers with a position of the container carrier to be applied to the group of containers. The method may further include configuring the controller to control a conveyance speed of the plurality of groups of containers such that a gap is introduced between the first group and the second group of the plurality of groups as they are conveyed along the conveyor toward the application device, the gap being spaced in a conveyance direction of the groups of containers. A potential advantage of this configuration is that a container carrier may be securely applied the first group of containers without interference from the second group of containers.

In this aspect, the method may further comprise configuring the controller to be a programmable logic controller, and electronically linking a first servomechanism and a second servomechanism, the first and second servomechanisms being controlled via the programmable logic controller. A potential advantage of this configuration is two components of the applicator system may be cooperatively controlled via the programmable logic controller such that the conveyance of the containers coordinates with the application of the container carrier.

In this aspect, the method may further include configuring the first servomechanism to control the container positioning device to refrain from conveying the second group of containers until the first group of containers reaches a predetermined distance from the container positioning device to introduce the gap between the first and second groups of containers. A potential advantage of this configuration is that a container carrier may be securely applied to the first group of containers without interference from the second group of containers.

In this aspect, the method may further include configuring the second servomechanism to control the application device to accelerate when seating the container carrier on the first group of containers to introduce the gap between the first and second groups of containers. A potential advantage of this configuration is that a container carrier may be securely applied to the first group of containers without interference from the second group of containers.

In this aspect, the method may further comprise including a roller applicator in the application device to secure container carriers onto top surfaces of the containers, the roller applicator being formed in a shape complimentary to a shape of a top surface of the container carrier. A potential advantage of this configuration is that a container carrier may be firmly seated on a group of containers.

In this aspect, the method may further include configuring the roller applicator to be adjustable in height. A potential advantage of this configuration is that the roller applicator of the system may be used to firmly seat container carriers on containers of different heights.

In this aspect, the method may further comprise including a stomp applicator in the application device that applies a downward force to press container carriers onto top surfaces of the containers. A potential advantage of this configuration is that a container carrier may be firmly seated on a group of containers.

In this aspect, the method may further include configuring a sensor to detect when the first group of containers reaches a predetermined distance from the container positioning device. A potential advantage of this configuration is that gaps between groups of containers can be consistently and accurately timed.

In this aspect, the method may further include configuring a sensor to detect when the roller applicator engages the container carrier on the first group of containers. A potential advantage of this configuration is that gaps between groups of containers can be consistently and accurately timed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic representation of a container carrier application system according to the present disclosure.

FIG. 2 is a side view of a container carrier application system according to the present disclosure.

FIG. 3 is a front view of a container carrier application system according to the present disclosure.

FIG. 4 is a perspective view of a container carrier application system according to the present disclosure.

FIG. 5 is an enlarged perspective view of a container carrier application system according to the present disclosure.

FIG. 6 is an enlarged rear perspective view of a container carrier application system according to the present disclosure.

FIG. 7 is an enlarged side view of a container carrier application system according to the present disclosure.

FIG. 8 is an enlarged front perspective view showing a roller applicator of a container carrier application system according to the present disclosure.

FIG. 9 is an enlarged front perspective view showing a stomp applicator of a container carrier application system according to the present disclosure.

FIG. 10 is a flowchart of a method for a container carrier application system according to the present disclosure.

### DETAILED DESCRIPTION

Selected embodiments of the present disclosure will now be described with reference to the accompanying drawings. It will be apparent to those skilled in the art from this disclosure that the following descriptions of the embodiments of the disclosure are provided for illustration only and not for the purpose of limiting the disclosure as defined by the appended claims and their equivalents.

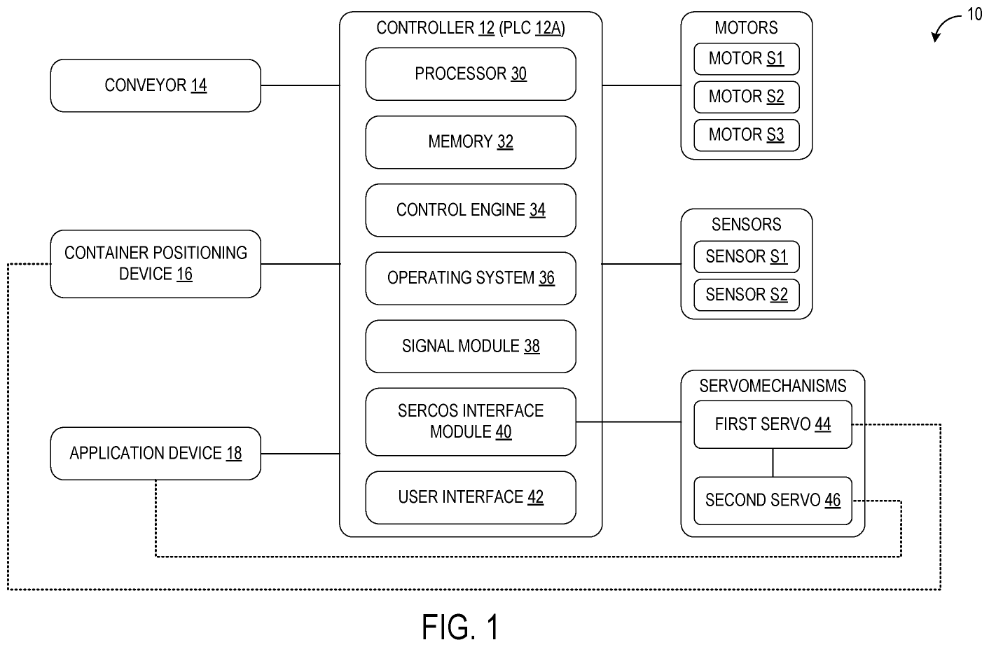

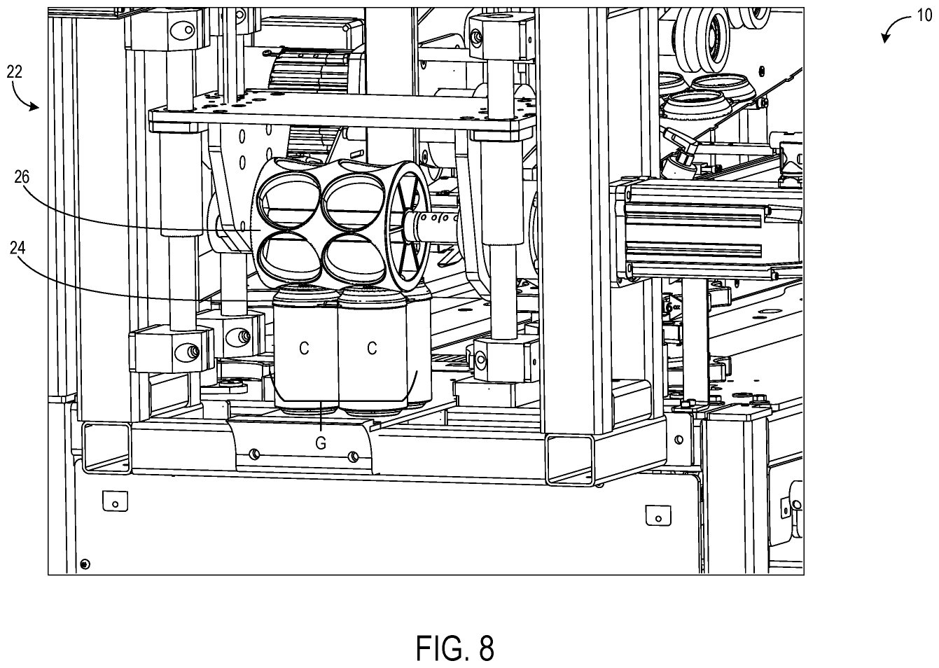

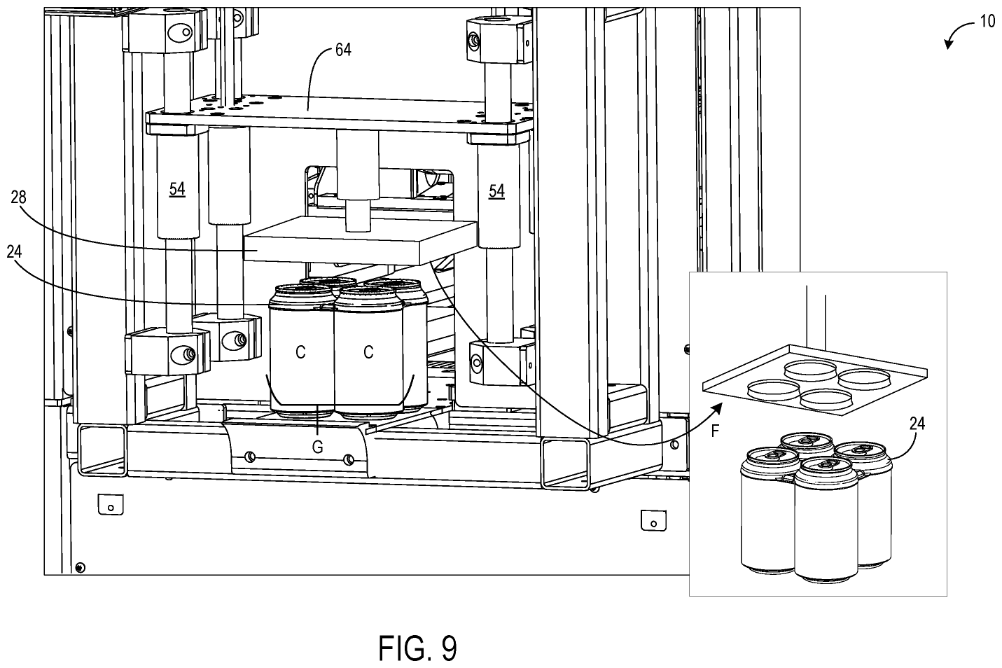

Turning to the figures, FIG. 1 illustrates a schematic representation of a container carrier application system 10. The container carrier application system 10 may comprise a controller 12, a conveyor 14, a container positioning device 16, and an application device 18. The conveyor 14, the container positioning device 16, and the application device 18 may be operated under command of the controller 12. The conveyor 14 may be implemented as a belt drive, for example, that is configured to convey a plurality of groups G of containers C from a supply side 20 to an output side 22. The container positioning device 16 may be configured to position each group G of containers C on the conveyor 14 for application of a container carrier 24 to the group G of containers C. The application device 18 may be configured to apply the container carrier 24 to the group G of containers C. As described below with reference to FIGS. 8 and 9, the application device 18 may include a roller applicator 26 and/or a stomp applicator 28.

The controller 12 may be configured as a programmable logic controller (PLC) 12A that includes a processor 30 and a memory 32. The PLC 12A may command a control engine 34 and an operating system 36 via the processor 30. At least one signal (I/O) module 38 may be included for connecting the PLC 12A to other devices, and a serial real-time communication system (SERCOS) interface module 40 may allow a user to control motion of components of the system 10, such as a motion of the container positioning device 16 and a motion of the application device 18 as described below, via a user interface 42 provided on the PLC 12A.

The system 10 may also include a first servomechanism 44 and a second servomechanism 46. The first and second servomechanisms 44, 46 may be electronically linked to one another and controlled via the SERCOS interface module 40 on the PLC 12A. The first servomechanism 44 may be configured to control the container positioning device 16, and the second servomechanism may be configured to control the application device. Motors M1, M2, and M3 may be included in the system 10 to drive the motion of the container positioning device 16, the motion of the application device 18, and a motion of the conveyor 14, respectively. When applying the container carrier 24 to the group G of containers C, the motion of the container positioning device 16 and the motion of the application device 18 may be synchronized to coordinate a position of the group G of containers C with a position of the container carrier 24 to be applied to the group G of containers C. Sensors S1 and S2 may be included in the system 10 to detect the position of the group G of containers C at predetermined locations with regard to the application device 18.

As the containers move along the conveyor 14 toward the application device 18, a container C of a first group G1 may be in contact with at least one container C of a second group G2. By controlling the motion of the container positioning device 16 and/or the motion of the application device 18, the controller 12 may be configured to control a conveyance speed of the plurality of groups G of containers C such that a gap is introduced between the first group G1 and the second group G2 of the plurality of groups G as they are conveyed along the conveyor 14 toward the application device 18, the gap being spaced in a conveyance direction CD of the groups G of containers C.

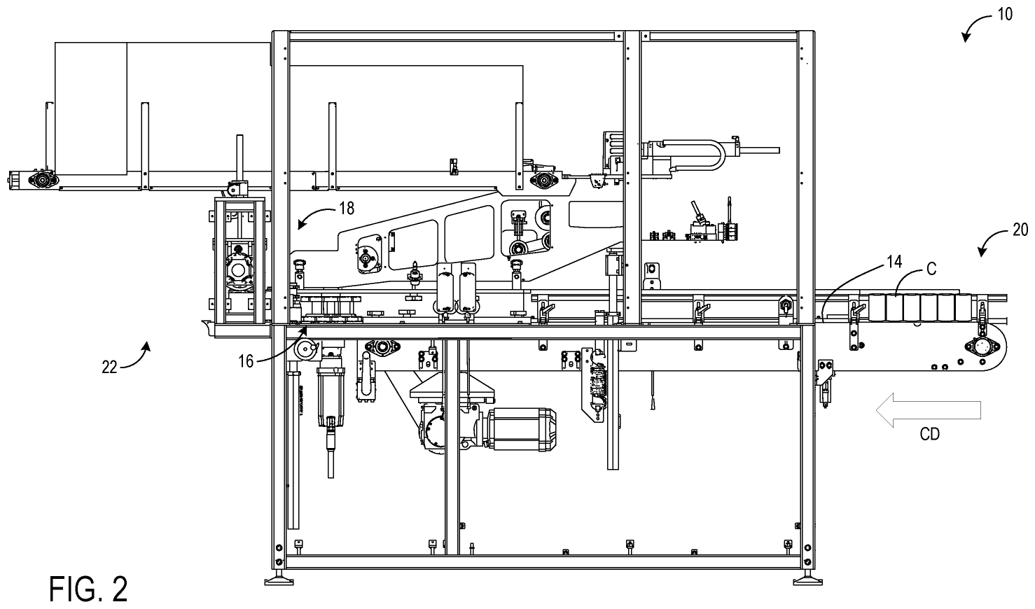

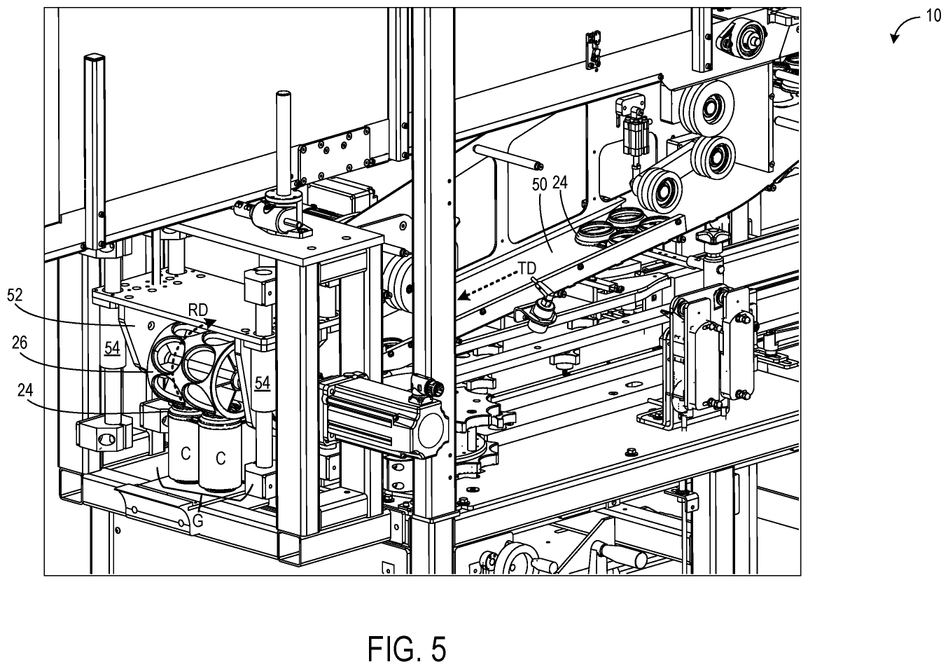

FIGS. 2, 3, and 4 show side, front, and perspective views, respectively, of the container carrier application system 10. FIG. 5 shows an enlarged front perspective view of the application device 18 of the system 10. In the illustrated implementation, the system 10 is configured with the application device 18 includes the roller applicator 26.

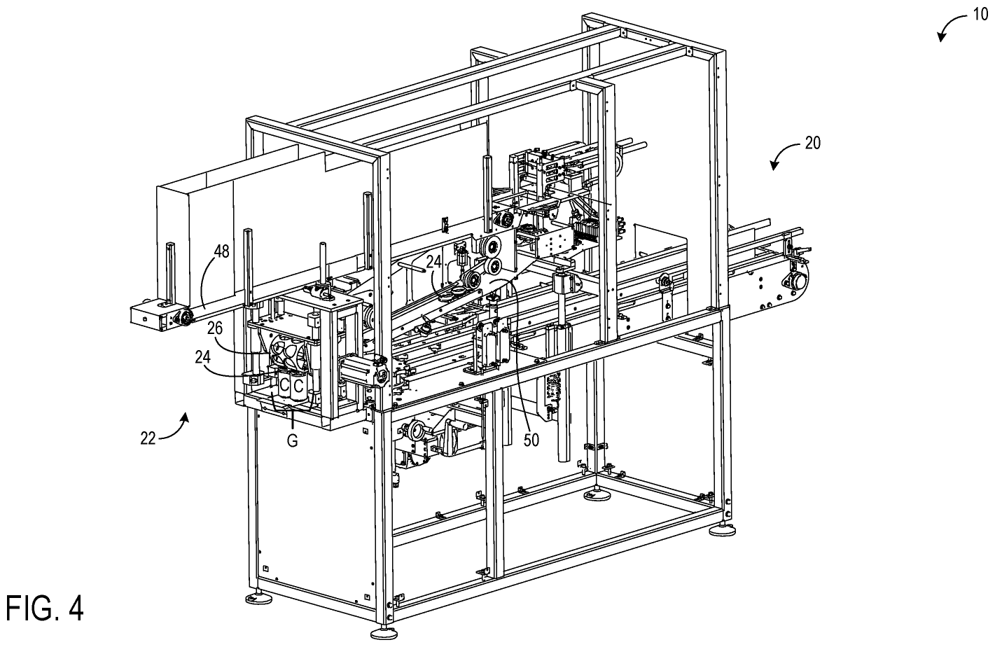

Turning first to FIG. 2, a side view of the system 10 is provided. A side panel is omitted from the illustration to permit components of the system 10 to be visible. As shown in FIG. 2, containers C may be placed on the conveyor 14 at the supply side 20 and move in a conveyance direction CD toward the output side 22 of the system 10, as indicated by the open arrow in FIG. 2. As the containers C move toward the application device 18, the container positioning device 16 aligns each container C in a group G for proper application of the container carrier 24. The loading and conveyance of the container carriers 24 is described in detail below with reference to FIGS. 4 and 5.

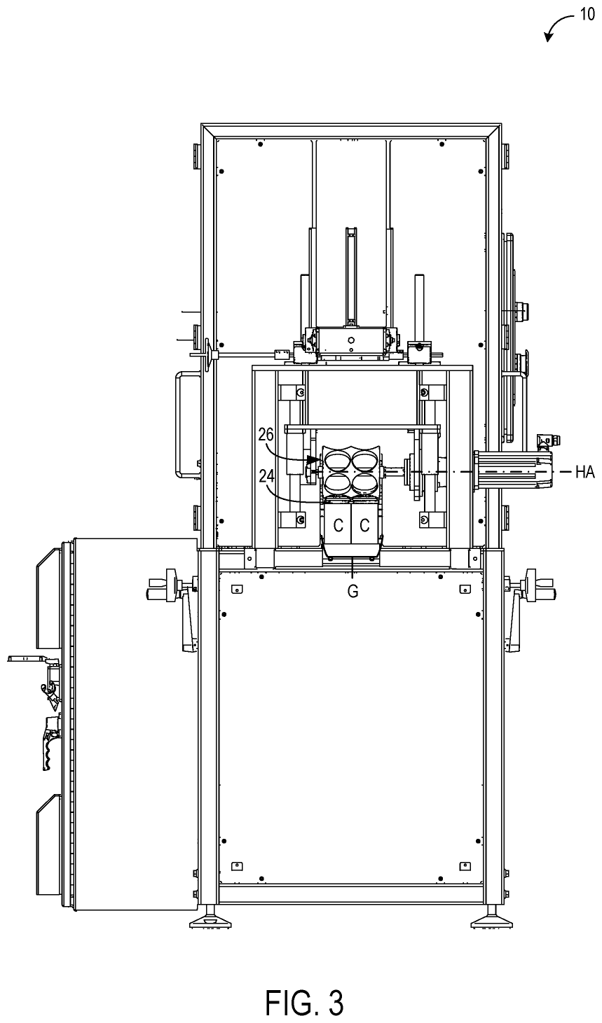

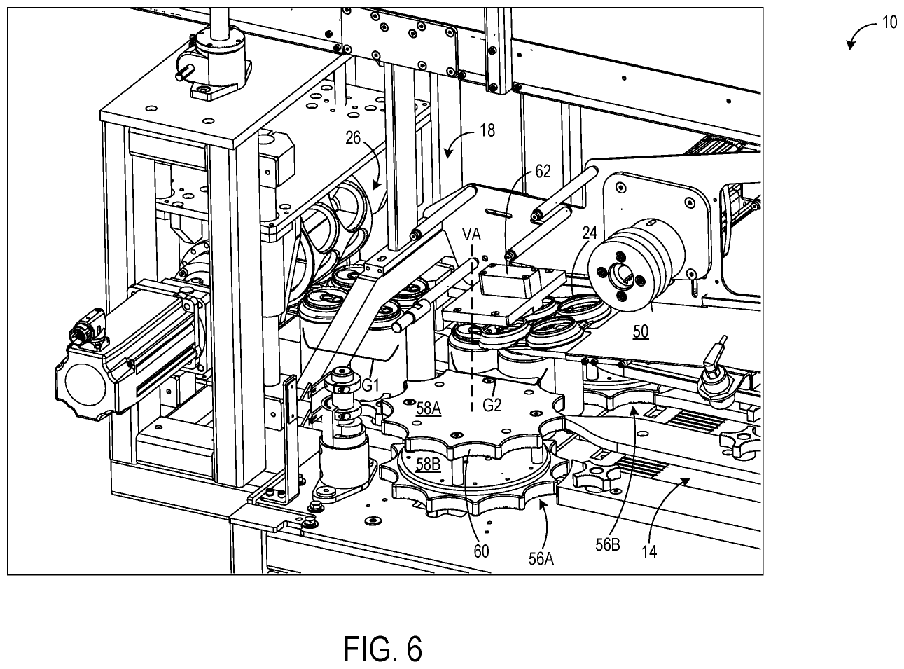

In FIG. 3, a front view of the system 10 illustrating the output side 22 is provided. As shown, the containers C may be arranged by pairs within the group G of containers, and each group G may include four, six, or eight containers C. In the implementations shown herein, the group G is comprised of four containers. However, it will be appreciated that containers C in a group G may be arranged in single file, and the group G may be comprised of a different number of containers C, such as two, three, or four, for example. The roller applicator 26 is positioned at the output side 22 of the system 10. With reference to FIG. 2, the roller applicator 26 is configured to rotate around a horizontal axis HA, as indicated by the dashed dot line in FIG. 3, in a direction opposite that of the conveyance direction CD of the conveyor 14. As the group G of containers C passes under the roller applicator 26, a rotational force is applied to the container carrier 24 by the roller applicator to secure the container carrier 24 onto top surfaces of the containers C. Accordingly and as discussed below with reference to FIG. 6, the roller applicator 26 may be formed in a shape complimentary to a shape of a top surface of the container carrier 24.

Turning to FIGS. 4 and 5, a front perspective view of the container carrier application system 10 is shown. Container carriers 24 may be grouped into stacks and loaded into the system 10 at a carrier loading platform 48 arranged at the output side 22 of the system 10. The container carriers 24 travel toward the supply side 20 of the system 10, and are released individually onto a carrier track 50. The carrier track 50 conveys each container carrier 24 towards the application device 18 where it is applied to a group G of containers C in a first step of container carrier application. A traveling direction TD of the carrier track 50 is indicated in FIG. 5 by a dashed arrow. The group G of containers C with the container carrier 24 then proceed toward the roller applicator 26, which securely seats the container carrier 24 onto the group G of containers C in a second step of container carrier application, as described above. FIGS. 4 and 5 show a group G of containers C as it traverses under the roller applicator 26. A rolling direction RD of the roller applicator 26 is indicated in FIG. 5 by a dashed arrow. Also as illustrated in FIG. 5, the roller applicator 26 may be adjustable in height by moving a housing 52 of the roller applicator 26 vertically along support posts 54. It should be noted that a side plate of the carrier track 50 was omitted from FIGS. 4 and 5 to permit visualization of the container carrier 24 on the carrier track 50.

FIG. 6 shows an enlarged rear perspective view of the system 10, with the first and second groups G1, G2 of containers progressing through the application device 18. As shown in FIG. 5 and described above, individual container carriers 24 travel down the carrier track 50 towards the application device 18. In the illustrated embodiment, the container positioning device 16 is configured as a pair of star wheels 56A, 56B. However, it will be appreciated that the container positioning device 16 may be implemented in an alternative configuration, such as a chute, for example. As shown in FIG. 6, the star wheels 56 rotate along vertical axes VA to align the containers C into a group G and drive them toward the application device 18. Each star wheel 56 may be comprised of two identical plates 58A, 58B arranged vertically with respect to one another and spaced such that a height of the star wheel 56 is at least half a height of the container C. Each plate 58 may be shaped to include a plurality of concavities 60 around a perimeter of the plate 58. Each plate 58 may have a same number of concavities 60, and the concavities 60 on the plate 58A may be aligned with the concavities 60 on the plate 58B such that the concavities on the plates 58A, 58B cooperatively engage a cylindrically shaped container C.

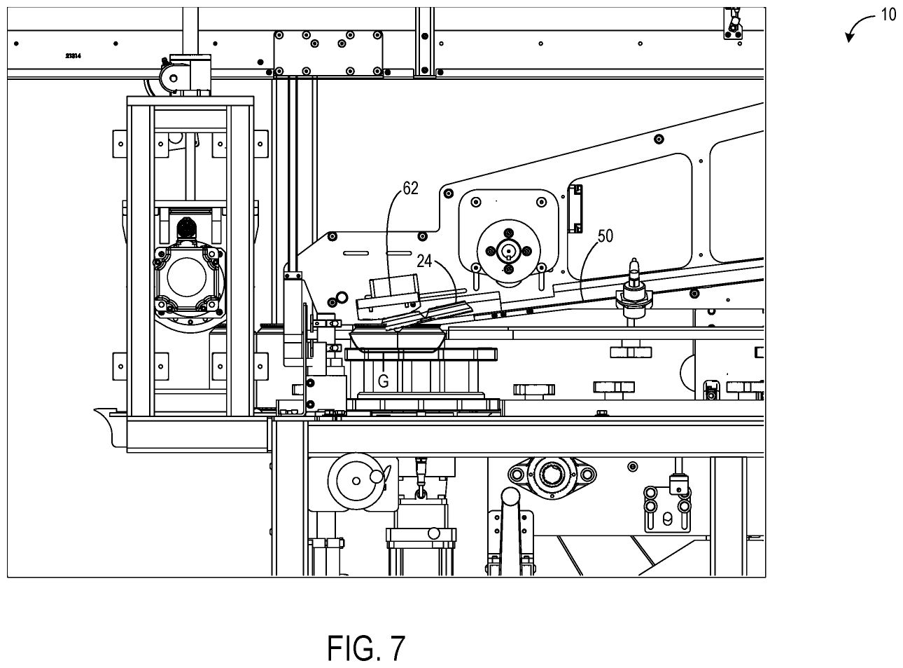

As groups G of containers C reach the end of the conveyor 14, each container C may be positioned by the star wheel 56 and aligned with other containers C in the group G. FIG. 6 illustrates containers C engaging with the pair of star wheels 56 and being aligned into the second group G2. As the containers C are aligned into the second group G2, a shoe 62 included in the application device 18 receives the container carrier 24 from the carrier track 50 and positions it onto the second group G2 of containers C. Turning briefly to FIG. 7, an enlarged side view of a container carrier application system 10 illustrates the shoe 62 receiving the container carrier 24 from the track 50 and positioning it onto the group G of containers C.

Turning back to FIG. 6, the container carrier 24 has been placed on the first group G1 of containers C, and the first group G1 is approaching the roller applicator 26. As described above, the roller applicator 26 may be formed to be a complimentary shape to the top surface of the container carrier 24 such that the roller applicator 26 securely seats the container carrier 24 onto the first group G1 of containers C as it passed underneath the roller applicator 26. This configuration is illustrated in FIG. 6, as the first group G1 of containers C beings to travel underneath the roller applicator 26, and in FIG. 8, as the group G of containers C emerges from the roller applicator 26 on the output side 22 of the system 10.

Conventionally, lagging containers C in the first group G1 are in contact with leading containers C from the second group G2 as the containers are conveyed through the application device 18. However, as discussed above, it may be preferable to include a gap between groups G of containers C in order to securely seat the container carriers 24, particularly when the containers C are configured as slim cans or if the container carrier 24 is designed to extend down a vertical side of a container C. Accordingly, in FIG. 6, the first and second groups G1, G2 of containers C are illustrated as being separated by a gap.

With reference to FIG. 1, the gap between the first and second groups G1, G2 of containers C may be achieved by the first servomechanism 44 controlling the container positioning device 16 to refrain from conveying the second group G2 of containers C until the first group G1 of containers C reaches a predetermined distance from the container positioning device 16 to introduce the gap between the first and second groups G1, G2 of containers C. As described above with continued reference to FIG. 1, the system 10 may include the sensor S1, which may be configured to detect when the first group G1 of containers C reaches a predetermined distance from the container positioning device 16. The sensor S1 may be implemented as an optical sensor, an infrared sensor, a photoelectric sensor, or the like, for example. Additionally or alternatively, the container positioning device 16 may be equipped with a rotary encoder to provide information regarding position, speed, or distance of the container positioning device 16 as it aligns containers into groups G.

Additionally or alternatively, with continued reference to FIG. 1, the gap between the first and second groups G1, G2 of containers C may be achieved by the second servomechanism 46 controlling the application device to accelerate when seating the container carrier 24 on the first group G1 of containers C to introduce the gap between the first and second groups G1, G2 of containers C. In this embodiment, the first group G1 of containers C may be conveyed on the conveyor 14 at a velocity V. When the first group G1 of containers travels beneath the roller applicator 26, the second servomechanism 46 may overdrive a speed of rotation of the roller applicator 26 to equal V+X %, thereby accelerating the first group G1 of containers C away from the second group G2 and introducing a gap between the first and second groups G1, G2 of containers C. With continued reference to FIG. 1, the system 10 may include the sensor S2, which may be configured to detect when the roller applicator 26 engages the container carrier 24 on the first group G1 of containers C. As with the sensor S1, the sensor S2 may be implemented as an optical sensor, an infrared sensor, a photoelectric sensor, or the like, for example. Additionally or alternatively, the roller applicator 26 may be equipped with a rotary encoder to provide information regarding position, speed, or distance of the roller applicator 26 as it engages the container carrier 24 on the first group G1 of containers C.

In some embodiments as discussed above, the application device 18 may include a stomp applicator 28, as shown in FIG. 9. The stomp applicator 28 may be configured to apply downward force to press container carriers 24 onto top surfaces of the containers C. The stomp applicator 28 may be configured as a telescoping hydraulic device, for example, that moves downward when the group G of containers is positioned underneath the stomp applicator 28. Like the roller applicator 26, the stomp applicator 28 may be adjustable in height by moving a mounting platform 64 of the stomp applicator 28 vertically along the support posts 54. A face F of the stomp applicator 28 may be formed in a shape complimentary to a shape of a top surface of the container carrier 24, as illustrated in the inset of FIG. 9. When the system 10 is equipped with the stomp applicator 28, the gap between groups of cans may achieved by controlling the container positioning device 16 to pause when conveying the second group G2 of containers C until the first group G1 is a predetermined distance away from the container positioning device 16.

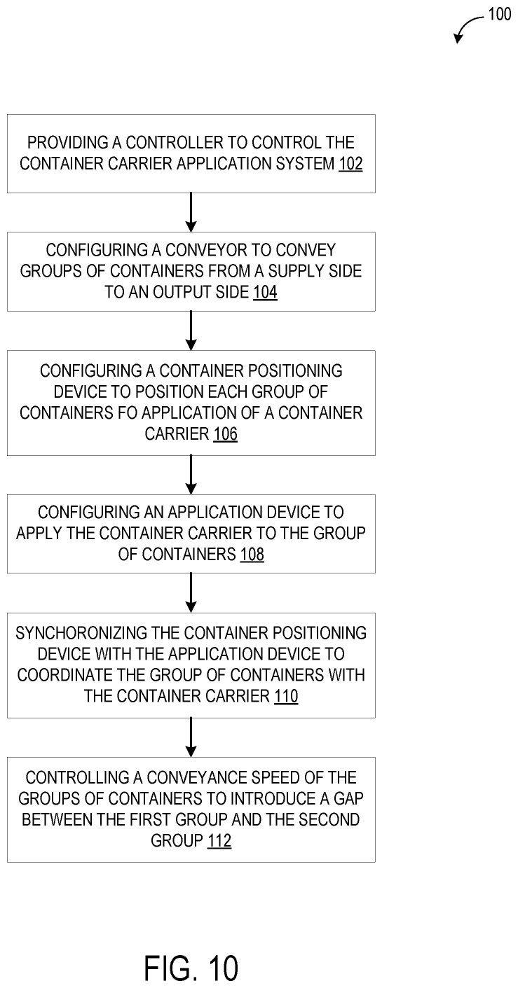

FIG. 10 shows a flow chart of a method 100 for the container carrier application system 10. At step 102, the method 100 may include providing a controller to control the container carrier application system. As described above, the controller may be configured as a programmable logic controller that is electronically linked to a first servomechanism and a second servomechanism, the first and second servomechanisms being controlled via the programmable logic controller. The first servomechanism may be configured to control the container positioning device to refrain from conveying the second group of containers until the first group of containers reaches a predetermined distance from the container positioning device to introduce the gap between the first and second groups of containers, and the second servomechanism may be configured to control the application device to accelerate when seating the container carrier on the first group of containers to introduce the gap between the first and second groups of containers.

At step 104, the method 100 may include configuring a conveyor to, under command of the controller, convey a plurality of groups of containers from a supply side to an output side, a container of a first group being in contact with at least one container of a second group.

At step 106, the method 100 may include configuring a container positioning device to, under command of the controller, position each group of containers on the conveyor for application of a container carrier to the group of containers. As described above, the system may include a sensor configured to detect when the first group of containers reaches a predetermined distance from the container positioning device. When the application device is configured to include the roller applicator, the system may include a sensor configured to detect when the roller applicator engages the container carrier on the first group of containers.

At step 108, the method 100 may include configuring an application device to, under command of the controller, apply the controller carrier to the group of containers.

At step 110, the method 100 may include synchronizing a motion of the container positioning device and a motion of the application device to coordinate a position of the group of containers with a position of the container carrier to be applied to the group of containers.

At step 112, the method 100 may include configuring the controller to control a conveyance speed of the plurality of groups of containers such that a gap is introduced between the first group and the second group of the plurality of groups as they are conveyed along the conveyor toward the application device, the gap being spaced in a conveyance direction of the groups of containers. As described above, the application device may include a roller applicator or a stomp applicator to secure container carriers onto groups of containers. The roller applicator and the stomp applicator may be configured to be adjustable in height to accommodate containers of varying heights.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A container carrier application system, comprising:
a controller;
a conveyor configured to, under command of the controller, convey a plurality of groups of containers from a supply side to an output side, a container of a first group being in contact with at least one container of a second group;
a container positioning device configured to, under command of the controller, position each group of containers on the conveyor for application of a container carrier to the group of containers; and
an application device configured to, under command of the controller, apply the container carrier to the group of containers, wherein
a motion of the container positioning device and a motion of the application device are synchronized to coordinate a position of the group of containers with a position of the container carrier to be applied to the group of containers, and
the controller is configured to control a conveyance speed of the plurality of groups of containers such that a gap is introduced between the first group and the second group of the plurality of groups as they are conveyed along the conveyor toward the application device, the gap being spaced in a conveyance direction of the groups of containers.

2. The container carrier application system of claim 1, wherein
the controller is configured as a programmable logic controller, and
a first servomechanism and a second servomechanism are electronically linked to one another and controlled via the programmable logic controller.

3. The container carrier application system of claim 2, wherein
the first servomechanism is configured to control the container positioning device to refrain from conveying the second group of containers until the first group of containers reaches a predetermined distance from the container positioning device to introduce the gap between the first and second groups of containers.

4. The container carrier application system of claim 2, wherein
the second servomechanism is configured to control the application device to accelerate when seating the container carrier on the first group of containers to introduce the gap between the first and second groups of containers.

5. The container carrier application system of claim 1, wherein
the application device includes a roller applicator to secure the container carrier onto top surfaces of the containers, the roller applicator being formed in a shape complimentary to a shape of a top surface of the container carrier.

6. The container carrier application system of claim 5, wherein
the roller applicator is adjustable in height.

7. The container carrier application system of claim 1, wherein
the application device includes a stomp applicator that applies a downward force to press the container carrier onto top surfaces of the containers.

8. The container carrier application system of claim 7, wherein
the stomp applicator is adjustable in height.

9. The container carrier application system of claim 3, further comprising:
a sensor configured to detect when the first group of containers reaches a predetermined distance from the container positioning device.

10. The container carrier application system of claim 5, further comprising:
a sensor configured to detect when the roller applicator engages the container carrier on the first group of containers.

11. A method for a container carrier application system, the method comprising:
providing a controller to control the container carrier application system;
configuring a conveyor to, under command of the controller, convey a plurality of groups of containers from a supply side to an output side, a container of a first group being in contact with at least one container of a second group;
configuring a container positioning device to, under command of the controller, position each group of containers on the conveyor for application of a container carrier to the group of containers;
configuring an application device to, under command of the controller, apply the container carrier to the group of containers;
synchronizing a motion of the container positioning device and a motion of the application device to coordinate a position of the group of containers with a position of the container carrier to be applied to the group of containers; and
configuring the controller to control a conveyance speed of the plurality of groups of containers such that a gap is introduced between the first group and the second group of the plurality of groups as they are conveyed along the conveyor toward the application device, the gap being spaced in a conveyance direction of the groups of containers.

12. The method for the container carrier application system of claim 11, the method further comprising:
configuring the controller as a programmable logic controller, and
electronically linking a first servomechanism and a second servomechanism, the first and second servomechanisms being controlled via the programmable logic controller.

13. The method for the container carrier application system of claim 12, the method further comprising:
configuring the first servomechanism to control the container positioning device to refrain from conveying the second group of containers until the first group of containers reaches a predetermined distance from the container positioning device to introduce the gap between the first and second groups of containers.

14. The method for the container carrier application system of claim 12, the method further comprising:
configuring the second servomechanism to control the application device to accelerate when seating the container carrier on the first group of containers to introduce the gap between the first and second groups of containers.

15. The method for the container carrier application system of claim 11, the method further comprising:
including a roller applicator in the application device to secure container carriers onto top surfaces of the containers, the roller applicator being formed in a shape complimentary to a shape of a top surface of the container carrier.

16. The method for the container carrier application system of claim 15, the method further comprising:
configuring the roller applicator to be adjustable in height.

17. The method for the container carrier application system of claim 11, the method further comprising:
including a stomp applicator in the application device that applies a downward force to press container carriers onto top surfaces of the containers.

18. The method for the container carrier application system of claim 13, the method further comprising:
configuring a sensor to detect when the first group of containers reaches a predetermined distance from the container positioning device.

19. The method for the container carrier application system of claim 15, the method further comprising:
configuring a sensor to detect when the roller applicator engages the container carrier on the first group of containers.

20. A container carrier application system, comprising:
a programmable logic controller;
a conveyor configured to, under command of the controller, convey a plurality of groups of containers from a supply side to an output side, a container of a first group being in contact with at least one container of a second group;
a container positioning device configured to, under command of the controller, position each group of containers on the conveyor for application of a container carrier to the group of containers; and
an application device configured to, under command of the controller, apply the container carrier to the group of containers, wherein
a motion of the container positioning device and a motion of the application device are synchronized to coordinate a position of the group of containers with a position of the container carrier to be applied to the group of containers,
the application device includes a roller applicator to secure container carriers onto top surfaces of the containers, the roller applicator being formed in a shape complimentary to a shape of a top surface of the container carrier, and
the controller is configured to accelerate the roller applicator such that a gap is introduced between the first group and the second group of the plurality of containers as they are conveyed along the conveyor toward the output side, the gap being spaced in a conveyance direction of the plurality of containers.
